(19) United States
(12) Patent Application Publication
(10) Pub. No.: US 2016/0003060 A1
(43) Pub. Date: Jan. 7, 2016

(54) HYBRID FAN BLADES FOR JET ENGINES

(71) Applicant: UNITED TECHNOLOGIES CORPORATION, Hartford, CT (US)

(72) Inventor: Katie L. Cook, Eliot, ME (US)

(21) Appl. No.: 14/766,486

(22) PCT Filed: Dec. 18, 2013
(86) PCT No.: PCT/US2013/075962

§ 371 Date: Aug. 7, 2015

Related U.S. Application Data
(60) Provisional application No. 61/774,121, filed on Mar. 7, 2013.

(51) Int. Cl. F01D 5/28; F01D 5/30; F01D 5/14

(52) U.S. Cl. CPC F01D 5/282; F01D 5/147; F01D 5/3007; F05D 2220/10; F05D 2230/60; F05D 2300/173; F05D 2300/174

(57) ABSTRACT

A fan blade for a jet engine, such as a turbo fan jet engine is disclosed. The fan blade includes a root for coupling the fan blade to a rotating hub. The root is connected to a blade portion or an airfoil. The blade includes a leading edge and a trailing edge. The leading edge includes at least one of a protrusion or a recess along the leading edge to enhance the structural characteristics of the blade portion. To ensure that the recess or recesses and/or protrusion or protrusions do not adversely affect the aerodynamic qualities of the fan blade, the leading edge of the blade portion is covered by a protective sheath. The sheath may be fabricated from a titanium alloy and is typically adhered to the blade portion using an adhesive, such as an epoxy.

### CROSS-REFERENCE TO RELATED APPLICATION

This Application is a US National Stage under 35 USC §371 of International Patent Application No. PCT/US2013/075962 filed on Dec. 18, 2013 based on U.S. Provisional Patent Application Ser. No. 61/774,121 filed on Mar. 7, 2013.

### TECHNICAL FIELD

This disclosure relates to fan blades that utilize protective sheaths and modifications to the leading edge of the fan blade to reduce damage from impact of objects striking the fan blades, such as birds.

### BACKGROUND

Fan blades for jet engines are typically designed to meet regulations relating to the impact of foreign objects against the fan blades while in operation. For example, regulations require a commercial airline jet engine to be capable of ingesting a medium-sized bird while allowing for continued operation or safe and orderly shutdown of that engine. Further, regulations also require that fan blades must resist cracking from nicks and dents caused by small debris such as sand and rain.

The design requirements may be especially challenging for hybrid fan blades constructed of fiber composite materials that may be less ductile than fan blades formed of metallic alloys. In some cases, fiber composite airfoils may include a nickel sheath for better resistance to erosion. However, nickel is relatively brittle and does not absorb enough energy in the event of a foreign object impact.

While titanium blades are relatively strong and lightweight, fiber composite blades offer sufficient strength and a significant weight savings over titanium. However, fiber composite fan blades are not suitable for smaller engines and the cost of fiber composite materials greatly exceeds that of titanium, which is also very costly. Both titanium and fiber composite raw materials are also expensive to process. Titanium and fiber composite fan blades often require expensive specialized equipment to process the material into an aerodynamic shape that maintains strength while keeping weight to a minimum. Fiber composite fan blades must have a greater thickness than metal or titanium fan blades to meet the bird strike regulations due to low strain tolerance of fiber composites. However, increasing the blade thickness reduces fan efficiency and offsets a significant portion of weight savings gained from using fiber composite materials.

Because of the cost of fiber composites and titanium and the lack of ductility of fiber composites, alternative materials are being investigated. One such material is aluminum-lithium alloys. Aluminum-lithium alloys, often include copper and zirconium, are significantly less dense than aluminum because lithium has the lowest density of all the metals. Alloying aluminum with lithium provides an alloy that is lighter, stiffer and stronger than an aluminum alloy. For example, every 1% by weight of lithium added to aluminum reduces the density of the resulting alloy by 3% and increases the stiffness by 5%.

Despite the advantages of Al—Li alloys, damage to the leading edge of an Al—Li fan blade of an aluminum alloy fan blade may occur in the event of a bird strike or engagement by smaller objects such as sand and debris. Damage to the leading edge of any fan blade can still occur even if a sheath, such as titanium sheath, is used to cover the leading edge of the fan blade. Such damage may be in the form of a crack, which will grow until the airfoil breaks off An obvious solution to reduce strain to the leading edge of a fan blade is to thicken the leading edge or the area of the leading edge that is subjected to high strains. However, this solution is undesirable because it adds weight and reduces the performance of the fan blade.

Thus, improved fan blades are needed with stronger leading edges than are currently available.

### SUMMARY

In one aspect, a fan blade for a jet engine is disclosed. The fan blade includes a root connected to a blade. The blade may include a leading edge and a trailing edge. The leading edge may include at least one protrusion along the leading edge. Further, the leading edge and the at least one protrusion may be covered by a sheath.

In another aspect, another fan blade for a jet engine is disclosed. This disclosed fan blade may include a root connected to a blade. The blade may include a leading edge and a trailing edge. The leading edge may include at least one recess disposed along the leading edge. The leading edge and the at least one recess may be covered by a sheath.

In yet another aspect, a method for increasing the strength of a leading edge of a blade portion of a fan blade for a jet engine is disclosed. The method may include forming a fan blade that may include a root connected to a blade. The blade may include a leading edge and a trailing edge. The method may further include forming at least one of a recess and a protrusion on the leading edge of the blade. The method may further include covering the leading edge and the at least one of the recess and protrusion with a sheath.

In any one or more of the embodiments described above, at least the blade may be fabricated from an aluminum-lithium alloy.

In any one or more of the embodiments described above, the blade may be fabricated from an aluminum alloy.

In any one or more of the embodiments described above, the sheath may be fabricated from a titanium alloy.

In any one or more of the embodiments described above, the leading edge may include both at least one protrusion and at least one recess, both of which are covered by the sheath. In the above-described method, the method may further include adhering the sheath to the leading edge with an epoxy.

### BRIEF DESCRIPTION OF THE DRAWINGS

FIG. 1 is a sectional view of a gas turbine engine.

FIG. 2 is a perspective view of a disc shaped hub equipped with a plurality of dovetail shaped slots that extend through an outer periphery of the disc shaped hub and a single fan blade assembly with a dovetail shaped root that has been received in one of the dovetail shaped slots of the hub.

FIG. 3 is a perspective view of a disclosed fan blade.

FIG. 4 is another perspective view of a disclosed fan blade with the sheath removed from the leading edge thereby exposing a recess disposed in the leading edge.

FIG. 5 is a partial enlarged perspective view of the fan blade shown in FIG. 4.

FIG. 6 is a partial perspective view of yet another disclosed fan blade illustrating the use of a protrusion disposed along the leading edge of the fan blade.

### DESCRIPTION

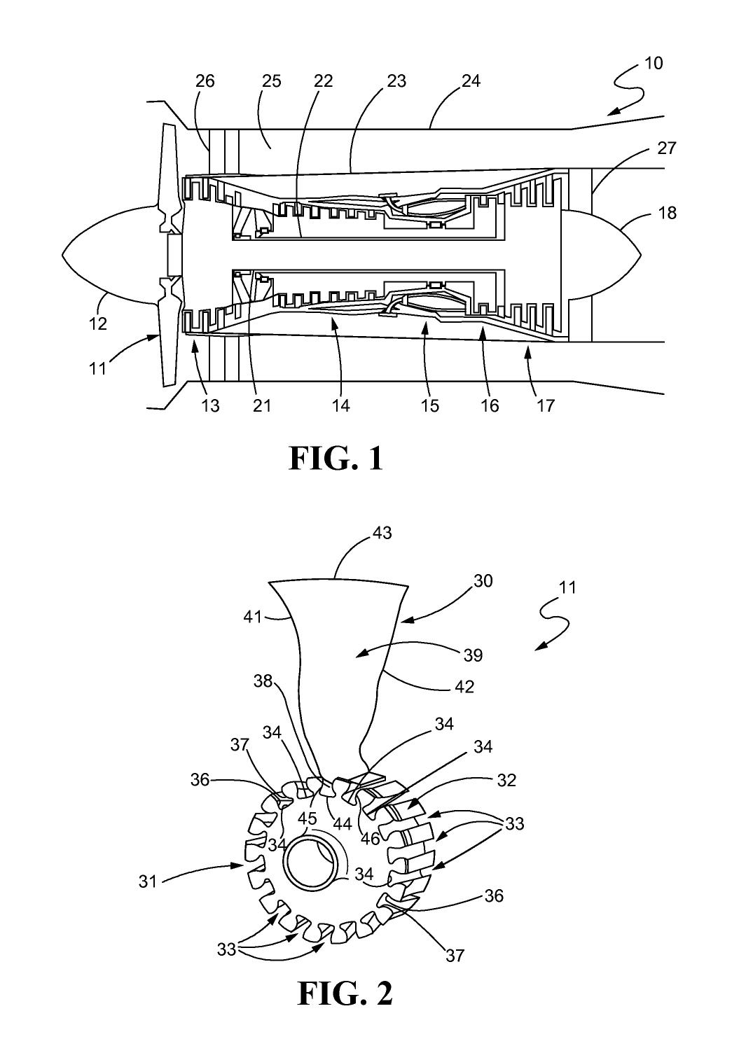

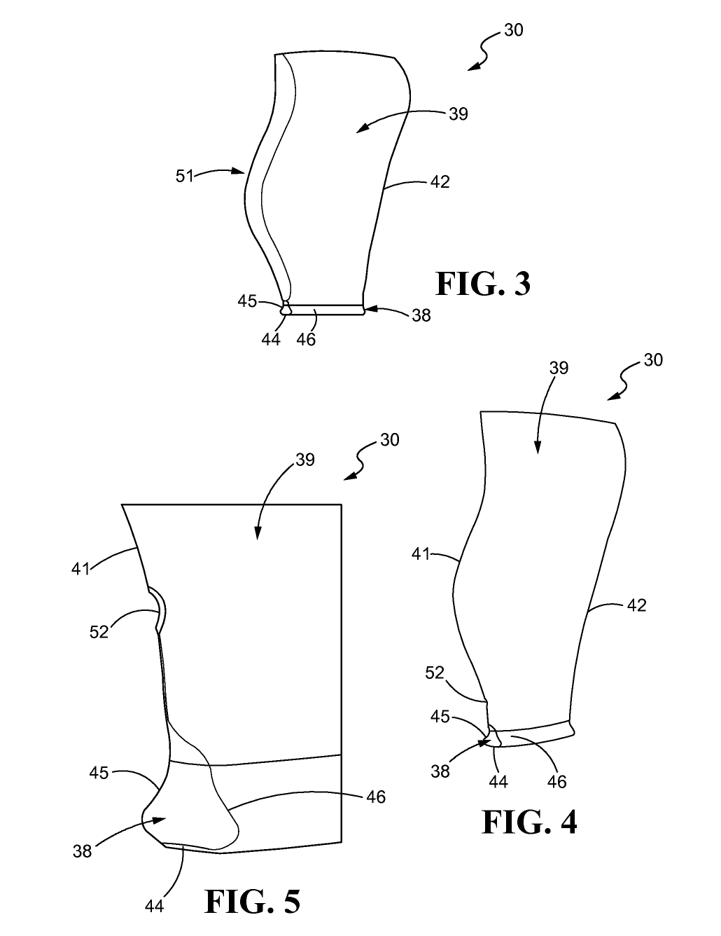

FIG. 1 is a sectional view of a disclosed gas turbine engine 10. The gas turbine engine 10 may include a fan assembly 11 that is disclosed in greater detail in connection with FIGS. 2-3. The fan blade assembly is mounted immediately aft of a nose cone 12 and immediately fore of a low pressure compressor (LPC) 13. The LPC 13 may be disposed between the fan blade assembly 11 and a high pressure compressor (HPC) 14. The LPC 13 and HPC 14 are disposed fore of a combustor 15 which may be disposed between the HPC 14 and a high pressure turbine (HPT) 16. The HPT 16 is typically disposed between the combustor 15 and a low pressure turbine (LPT) 17. The LPT 17 may be disposed immediately fore of a nozzle 18. The LPC 13 may be coupled to the LPT 17 via a shaft 21 which may extend through an annular shaft 22 that may couple the HPC 14 to the HPT 16. An engine case 23 may be disposed within an outer nacelle 24. An annular bypass flow path may be created by the engine case 23 and the nacelle 24 that permits bypass airflow or airflow that does not pass through the engine case 23 but, instead, flows from the fan assembly 11, past the fan exit guide vanes 26 and through the bypass flow path 25. One or more frame structures 27 may be used to support the nozzle 18.

Turning to FIG. 2, the fan blade assembly 11 may include a plurality of fan blades 30 mounted to a disc shaped hub 31. More specifically, the disc shaped hub 31 may include an outer periphery through which a plurality of dovetail shaped slots 33 extend. The dovetail shaped slots 33 may include inner surfaces 34. The inner surfaces 34 are each disposed between inwardly slanted walls 36, 37 that extend inwardly towards each other as they extend radially outwardly from their respective inner surfaces 34. As also shown in FIG. 2, the dovetail shaped slots 33 may each accommodate a dovetail shaped root 38 of a fan blade 30. The dovetail shaped root 38 is connected to a blade 39 that includes a leading edge 41 and a trailing edge 42. The leading and trailing edges 41, 42 are disposed on either side of the blade tip 43. As shown in FIG. 4, the dovetail shaped root 38 may include an inner face 44 that may be disposed between and connected to inwardly slanted pressure faces 45, 46. The pressure faces 45, 46 each engage the inwardly slanted walls 36, 37 respectively of their respective dovetail shaped slot 33.

As shown in FIG. 3, the fan blade 30 may include a protective sheath 51 that covers the leading edge 41 (see FIGS. 4-5) of the blade portion 39 of the fan blade 30. In one example, the sheath 51 is fabricated from a titanium alloy. In another example, the titanium alloy includes aluminum and vanadium. In other examples, the alloy may be a Ti-6Al-4V alloy, which typically has a yield strength ranging up to about 120 ksi (830 MPa) but is much heavier than the lightweight material used to fabricate the blade 39 and the root 38. Alternatively, other high strength metallic materials used in aircraft construction or aircraft engines may also be suitable for the sheath 51. Such examples include, but are not limited to nickel and nickel alloys. If a nickel alloy is used, it may contain cobalt, aluminum or both.

The blade 39 and root 38 may be fabricated from the same material and may be unitary in construction. For example, the blade portion 39 and root portion 38 may be fabricated from a 6××× or a 7××× series aluminum alloys, which are less costly to produce than titanium blades. Another option is to use an aluminum-lithium alloy, wherein the lithium content may range from about 1% to about 4%.

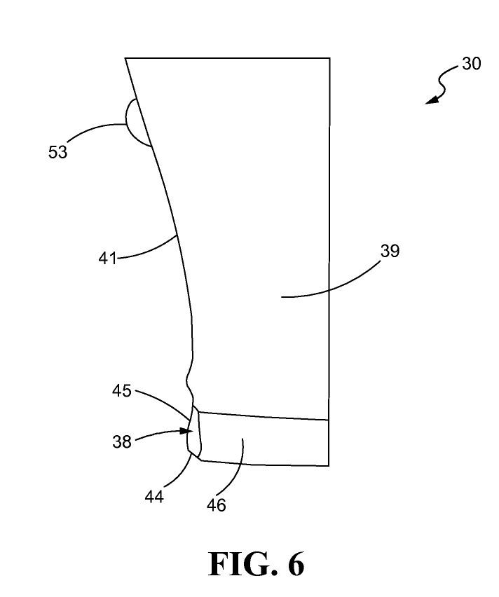

In addition to the protective sheath 51, other modifications to the leading edge 51 may be made. Referring to FIGS. 4-5, a recess 52 may be strategically placed along the leading edge 41 of the blade portion 39 of the fan blade 30. The recess 52 may be utilized to enhance the strength or ductility of the fan blade 30. While the recess 52 as shown in FIGS. 4-5 is disposed close to the root 38, the recess 52 may be placed anywhere along the length of the leading edge 41. Similarly, turning to FIG. 6, instead of a recess 52, a protrusion 53 is disposed along the leading edge 41 of the blade portion 39 of the fan blade 30. Again, the protrusion 53 may be strategically placed to enhance the strength and/or ductility of the blade portion 39 of the fan blade 30. As a result of the use of both recesses 52 and protrusions 53, the fan blades 30 may be made stronger and more ductile.

These properties will improve the ability of the fan blades 30 to withstand bird strikes and other objects that may engage the fan blades 30. The leading edge 41 may include both recesses 52 and protrusions 53. Or, the leading edge 41 may include a plurality of recesses 52 or a plurality of protrusions 53. Finally, the leading edge 41 may include a plurality of recesses 52 and a plurality of protrusions 53. In any event, the sheath 51 is used to cover the recesses 52 and the protrusions 53 so as to not affect the aerodynamic qualities of the fan blades 30. Further, the fan blades 30 may be tuned by placing recesses 52 or protrusions 53 in appropriate places, depending upon the shape of the blade 39 (also known as an airfoil).

### INDUSTRIAL APPLICABILITY

The ability of aluminum alloy fan blades or aluminum-lithium alloy fan blades 30 is enhanced by the strategic placement of recesses 52 and/or protrusions 53 along the leading edges 41 of the fan blades 30. Depending upon the particular shape of the blade portion 39 (or airfoil) the fan blades 30 may be tuned to enhance their strength and ductility and ability to withstand bird strikes. A protective sheath 51, that may be made from a titanium alloy, is used to cover the leading edge 41 so the recesses 52 and protrusions 53 do not adversely affect the aerodynamic qualities of the fan blades 30.

1. A fan blade for a jet engine, the fan blade comprising:
a root connected to a blade portion, the blade portion including a leading edge and a trailing edge,
the leading edge including at least one protrusion along the leading edge, the leading edge and the at least one protrusion being covered by a sheath.

2. The fan blade of claim 1 wherein at least the blade portion is fabricated from an aluminum-lithium alloy.

3. The fan blade of claim 1 wherein at least the blade portion is fabricated from an aluminum alloy.

4. The fan blade of claim 1 wherein the sheath is fabricated from a titanium alloy.

5. The fan blade of claim 1 wherein the leading edge further includes at least one recess, the at least one recess being covered by the sheath.

6. A fan blade for a jet engine, the fan blade comprising:
a root connected to a blade portion, the blade portion including a leading edge and a trailing edge,
the leading edge including at least one recess along the leading edge, the leading edge and the at least one recess being covered by a sheath.

7. The fan blade of claim 6 wherein at least the blade portion is fabricated from an aluminum-lithium alloy.

8. The fan blade of claim 6 wherein at least the blade portion is fabricated from an aluminum alloy.

9. The fan blade of claim 6 wherein the sheath is fabricated from a titanium alloy.

10. The fan blade of claim 6 wherein the leading edge further includes at least one protrusion, the at least one protrusion being covered by the sheath.

11. A method for increasing strength of a leading edge of a blade portion of a fan blade for a jet engine, the method comprising:
forming a fan blade including a root connected to a blade portion, the blade portion including a leading edge and a trailing edge;
forming at least one of a recess and a protrusion on the leading edge; and
covering the leading edge and the at least one of the recess and protrusion with a sheath.

12. The method of claim 11 further including:
adhering the sheath to the leading edge with an epoxy.

13. The method of claim 11 wherein at least the blade portion is fabricated from an aluminum-lithium alloy.

14. The method of claim 11 wherein at least the blade portion is fabricated from an aluminum alloy.

15. The method of claim 11 wherein the sheath is fabricated from a titanium alloy.
